(19) United States
(12) Patent Application Publication
(10) Pub. No.: US 2004/0249746 A1
(43) Pub. Date: Dec. 9, 2004

(54) Optimized management of E-Commerce transactions

(76) Inventors: Evan Horowitz, San Francisco, CA (US); Michael Landau, Greenbrae, CA (US)

Correspondence Address: PERKINS COIE LLP, P.O. BOX 2168, MENLO PARK, CA, 94026, US

(21) Appl. No.: 10/458,160

(22) Filed: Jun. 9, 2003

(51) Int. Cl. G06F 17/60

(52) U.S. Cl. 705/39

(57) ABSTRACT

A method and system are described for providing a turn-key solution for optimized management of E-commerce transactions. In certain embodiments, a merchant or service company is offered the capability of conveniently offering goods and services for sale online by using a turn-key solution for managing the E-commerce transactions associated with the sale. According to certain embodiments, the turn-key solution includes an optimization technique for completing, in an efficient and successful manner, each E-commerce transaction to which the turn-key solution is applied.

### FIELD OF THE INVENTION

This invention relates to E-Commerce transactions and, more specifically, to providing a turn-key process for managing E-Commerce transactions.

### BACKGROUND OF THE INVENTION

When a consumer shops online, the merchant offering merchandise for sale online must provide the consumer with a payment process. The payment process enables the consumer to make an online payment for the merchandise that the consumer has ordered. Similarly, a service company has to provide a payment process to enable a consumer who has made an online order for services to make an online payment for the order.

In one approach, each merchant or service company bears the burden of establishing working relationships and service agreements with one or more billing services. In addition, each merchant or service company would also bear the burden of integrating their online systems with that of the billing services. Examples of billing services are iBill, Epoch Systems (also known as PayCom), and CCBill.

Billing services are business entities that are capable of billing the price of the merchandise or price of the service to one or more of the following: 1) a credit card service, 2) a 900 number, 3) a debit-card account, 4) a checking account, 5) or some other payment-service entity. In other words, each billing service offers a number of methods of billing. Examples of credit card services are Visa, MasterCard and American Express. One example of other payment-service entities is PayPal.

When the merchant or service company has a service agreement with only one billing service, and if the billing service is temporarily out of commission or is unable to accept a given online transaction for processing, then the merchant or service company has no recourse but to reject the consumer's purchase offer.

In the case where the merchant or service company has service agreements with more than one billing service, the merchant or service company still bears the burden of interfacing with each billing service in a serial fashion until the given online transaction is successfully processed. Such a method of interfacing with each billing service is cumbersome to the merchant or service company. Further, current methods of interface to successive billing services move only in a linear, “cascading” fashion. In other words, a single queue of successive merchant billing services determines the path of all given transactions (for example, if Merchant A fails, try Merchant B; if Merchant B fails, try Merchant C; etc.). However, such cascades through successive processor options are uni-directional and rely on a predetermined and mutually exclusive order of precedence across all transaction attempts. Thus, such cascades are not optimized for any individual consumer's transaction and cannot provide for any advanced or intelligent routing of individual transactions.

Based on the foregoing, there is a need to provide E-Commerce merchants and service providers a turn-key solution for advanced or optimized management of E-commerce transactions.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a high-level functional overview of certain embodiments;

FIG. 2 is a flow chart that illustrates some of the details of the performance-commerce processing mechanism;

FIG. 3 is a flow chart that illustrates some of the details of the act of interpreting a given transaction request;

FIG. 4 is a flow chart that illustrates some of the details of the performance-commerce processing and optimization technique for determining the optimal processor; and

FIG. 5 is a flow chart that illustrates the confirmation process and the merchant fulfillment process.

### DETAILED DESCRIPTION OF THE PREFERRED EMBODIMENT

A method and system are described for providing a turn-key solution for managing E-commerce transactions. In certain embodiments, a merchant or service company is offered the capability of conveniently offering goods and services for sale online by using a turn-key solution for managing the E-commerce transactions associated with the sale. Specifically, the E-Commerce transactions refer to the processing of payment information for each transaction initiated by a customer who is making an online purchase. According to certain embodiments, the turn-key solution includes a convenient plug-in computer interface associated with the merchant's web site. Another feature of the turn-key solution obviates the need for the merchant to establish individual working relationships and service agreements with each billing service. Further, the turn-key solution includes an optimization technique for completing, in an efficient and successful manner, each E-commerce transaction to which the turn-key solution is applied.

In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Functional Overview

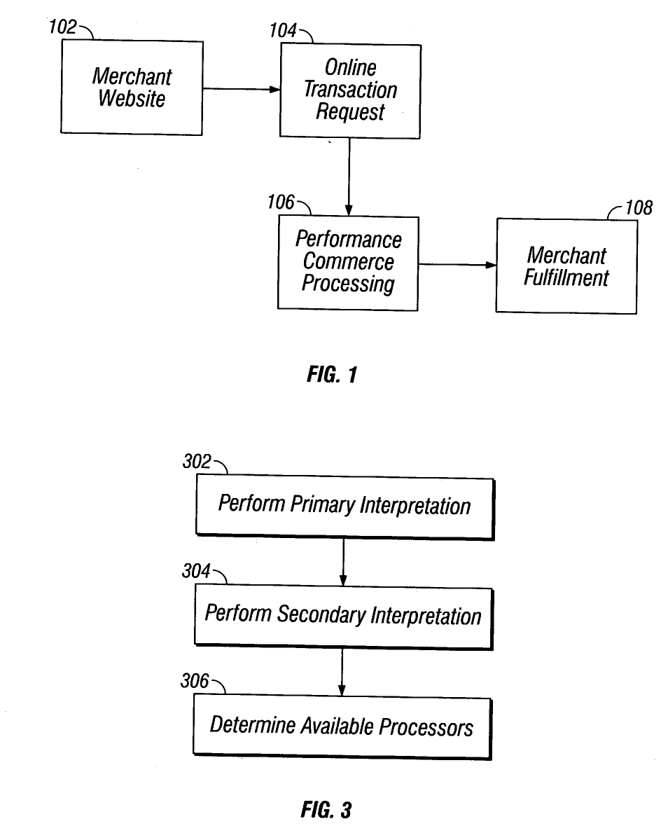

FIG. 1 is a block diagram that illustrates a high-level functional overview of certain embodiments. Block 102 represents a merchant web site. Merchant web site 102 includes a convenient plug-in interface (not shown in FIG. 1). From the merchant web site 102, a transaction request 104 is initiated using the plug-in interface. For example, a customer who is browsing merchant web site 102 decides to make an online purchase and thus initiates the online transaction request 104.

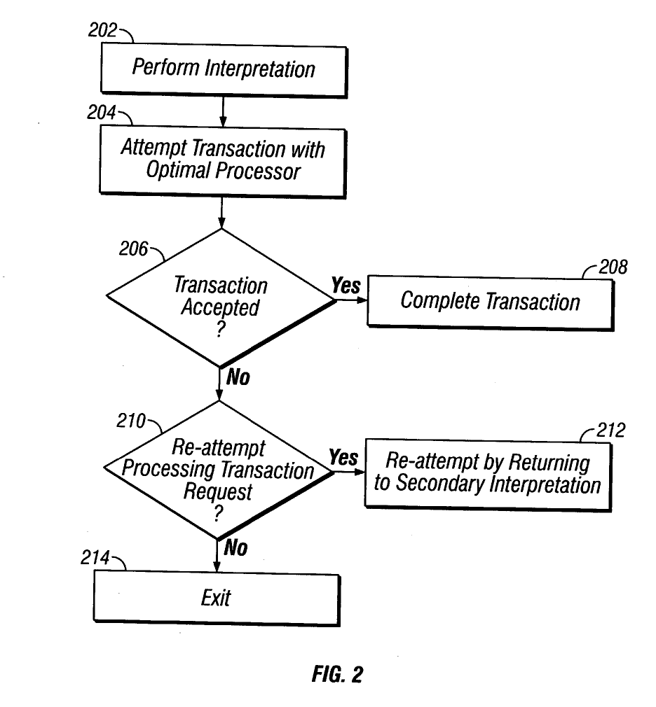

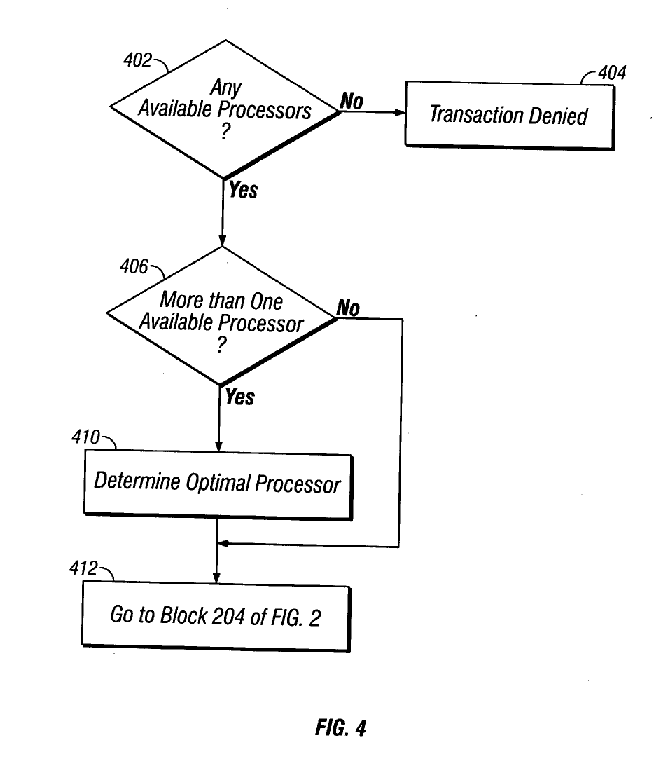

The transaction request is processed using a performance-commerce processing mechanism as indicated at block 106. One of the features of the performance-commerce processing mechanism is the ability to interface with each of the billing services with which the performance-commerce processing mechanism has a pre-established working relationship. A billing service with which the performance-commerce processing mechanism has a pre-established working relationship is hereafter referred to as a “processor”. Performance-commerce processing is described in greater detail herein with respect to FIG. 2. Performance-commerce processing is usually performed by an intermediary third-party entity. Thus, the performance-commerce processing of the transaction request is transparent to both the merchant and the merchant's customer.

When a transaction that is associated with transaction request 104 is successfully completed, then merchant fulfillment takes place as indicated by block 108. Merchant fulfillment means that the purchased goods associated with transaction request 104 is shipped to the customer.

In certain other embodiments, the customer may initiate transaction request 104 via telephone or e-mail. In such a case, the sales representative that receives the telephone call or e-mail uses the plug-in interface to initiate an online transaction request for the customer.

According to one embodiment, the performance-commerce processing mechanism handles customer service for those processors that wish to outsource their customer service function. For example, if a customer requests cancellation of a completed transaction, the performance-commerce processing mechanism can take care of the cancellation request for the processor that completed the transaction, if the processor so desires. According to certain embodiments, the performance-commerce processing mechanism is operable to handle any function that a processors wishes to outsource.

### Performance-Commerce Processing

FIG. 2 is a flow chart that illustrates some of the details of the performance-commerce processing mechanism. At block 202, the performance-commerce processing mechanism performs interpretation of the transaction request. The act of performing interpretation of the transaction request is described in greater detail herein with reference to FIG. 3.

At block 204 of FIG. 2, an attempt is made to process the transaction request using an optimal processor. The optimal processor is determined using an optimization technique. The optimization technique may vary from implementation to implementation. The optimization technique, according to certain embodiments, is described in greater detail herein with reference to FIG. 4.

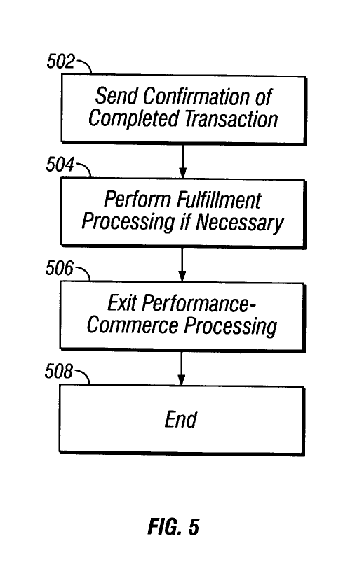

At block 206 of FIG. 2, it is determined whether the transaction request has been accepted by the optimal processor. If it is determined that the transaction request has been accepted by the optimal processor, then the transaction that is associated with the transaction request is completed by the optimal processor. The completion procedure of the transaction that is associated with the transaction request is described in greater detail herein with reference to FIG. 5.

If at block 206 of FIG. 2, it is determined that the transaction request is not accepted by the optimal processor, then at block 210 it is determined whether another attempt is to be made to process the transaction request.

If it is determined that another attempt is to be made to process the transaction request, then at block 212, the transaction request is re-inserted for more interpretation, as described below at block 304 of FIG. 3. If it is determined that no other attempt is to be made to process the transaction request, then at block 214, the procedure exits the performance-commerce processing mechanism.

### Interpretation

FIG. 3 is a flow chart that illustrates some of the details of the act of interpreting a given transaction request. At block 302, a primary interpretation of the transaction request is performed. After the primary interpretation is complete, a secondary interpretation of the transaction request is performed at block 304. At block 306, the available processors for processing the transaction request are determined. The determination of the available processors for processing the transaction request is described in greater detail herein with reference to FIG. 4.

According to certain embodiments, the primary interpretation of the transaction request includes the following optional features: 1) evaluation and/or verification of referrer data, 2) evaluation and/or verification of geotarget data, 3) performing a fraud scrub, and 4) evaluation and/or verification of the type of commerce associated with the transaction request. The foregoing optional features of the primary interpretation may vary from implementation to implementation. Further, according to certain embodiments, the primary interpretation may include additional optional features.

The evaluation and/or verification of referrer data include tracking the web site that referred the transaction. The web site that referred the transaction is herein referred to as the referral web site. For example, assume, for purposes of explanation, that the consumer generated the transaction request in response to a banner advertisement displayed on the referral web site. The referral web site may also contain a link to the merchant web site where the consumer may be lead to initiate the online transaction request. In such a case, the evaluation and verification of the referrer data may result in recording information associated with the referral web site for the purpose of awarding the referral web site a referral fee. Another reason for evaluation and/or verification of the referrer data may be for the purpose of determining whether the referral web site offers its own payment system to the consumer. According to certain embodiments, the referral web site's payment system may be considered the optimal processor if certain other criteria are satisfied during the optimization calculus.

The evaluation and/or verification of geotarget data include the determination of the country of origin associated with the IP address from which the transaction request originated. The IP address from which the transaction request originated is herein referred to as the source IP address. The evaluation and/or verification of geotarget data may also include determining state and/or zip code information. Further, the evaluation and verification of geotarget data may also include determining whether the transaction request was sent from the source IP address using a high-speed connection versus a low-speed connection. Geotarget data may also be used in determining whether to allow the transaction request to be processed further. For example, if the geotarget data indicates that the source IP address is from a country with which it is illegal to conduct business according to regional laws or the laws of the United States, then the transaction may be denied without further processing. The geotarget data may also be used in determining the type of payment method to offer to the consumer. For example, if the geotarget data indicates that the source IP address is from Europe where wireless phone messaging is popular, then a decision may be made to offer the consumer the opportunity to make a payment by charging the payment against the consumer's wireless phone number or land-line phone number.

The act of performing a fraud scrub includes checking the transaction request against a database. For example, the database may store information on source IP addresses that have a history of originating fraudulent transaction requests. The database may also store information on source IP addresses that have a history of originating successful and fraud-free transaction requests. As another example, the database may store information on fraudulent e-mail addresses. The fraud scrub procedure would compare the e-mail address submitted by the consumer against the fraud scrub database. Yet another example of a fraud scrub is when the consumer, who is initiating the transaction request, claims to be in the United States but the source IP address shows that the consumer is in Eastern Europe.

The evaluation and/or verification of the type of commerce associated with the transaction request involve determining what type of commercial product is associated with the transaction request. For example, if the type of commercial product associated with the transaction request is a gambling product, such as a lottery ticket, and the geotarget data indicates that the source IP address is from a state where gambling is illegal, then the transaction request may be denied without further processing. Further, the determination of the type of commercial product may be needed to determine the fulfillment processing associated with the product. For example, if the type of commercial product indicates a membership subscription, then there is no drop shipment involved during fulfillment processing. Fulfillment processing is described in greater detail herein with reference to FIG. 5.

According to certain embodiments, the secondary interpretation of the transaction request includes the following optional features: 1) request historical data for evaluation and/or verification of any previous transaction requests attempted by the same consumer who is submitting the current transaction request, 2) request that the consumer select a payment method and evaluate and/or verify the selected payment method, 3) perform cross-selling and/or up-selling.

In respect to requesting historical data, according to certain embodiments, the performance-commerce processing system is operable to communicate with a database that stores historical data on transaction requests for each consumer for whom transaction requests have been processed by the performance-commerce processing mechanism in the past. The evaluation of the historical data on transaction requests for the same consumer who is submitting the current transaction request allows the performance-commerce processing mechanism to determine the information that includes but is not limited to:

a) the identity of the processors with which this particular consumer has had success in the past for processing her transaction requests. Information on processors with which this particular consumer has had success in the past is used in the optimization calculus for determining the optimal processor as described herein with reference to FIG. 4.

b) the identity of the types of products that this particular consumer has bought or attempted to buy in the past. The information on the types of products that this particular consumer has bought or attempted to buy in the past can be used for cross-selling and/or up-selling related products to this particular consumer.

c) whether the transaction request is being re-inserted for a secondary interpretation in a re-attempt at processing. Re-insertion of a transaction request is described herein with reference to block 212 of FIG. 2.

In respect to requesting that the consumer select a payment method, the consumer may be presented with a graphical user interface (GUI) that lists the available payment methods. For example, payment can be made:

a) by a credit card from any one of several credit card companies

b) by electronic check (ACH),

c) by charging against a 900 phone number,

d) by a bank debit card,

e) by charging against a wireless service account (UK SMS billing, for example).

In respect to the cross-selling and/or up-selling, the cross-selling and/or up-selling of related products can be in the form of concurrent or subsequent transaction options offered to the consumer. According to certain embodiments, a feature that is related to cross-selling and/or up-selling may be to offer the consumer the same product from another merchant that offers an alternative billing method through an alternative processor. In such case, the consumer's transaction request can be processed concurrently through both processors in order to increase the odds of successfully completing the transaction associated with the given transaction request.

### Optimization

The optimization technique for determining which processors are available to process a transaction request at a given time may vary from implementation to implementation. According to certain embodiments, the performance-commerce processing mechanism is operable to communicate with a rules engine. The rules engine comprises rules that aid in the determination of available processors and in the determination of the optimal processor when more than one processor is available. For example, the rules in the rules engine are based on: 1) configuration settings provided by each of the processors, 2) analysis of the processing trends of each processor as a function of a set of variables. The rules engine is dynamic and evolves as more transaction requests are processed by the performance-commerce mechanism. In other words, the rules engine evolves as more information is gathered about the processing behavior of each processor and about consumer behavior. Further, the rules engine adapts to the variable configuration settings of each of the processors. Such rules are useful when applied to the individual transaction request's characteristics that are recognized in the interpretation steps of the performance-commerce processing mechanism for determining which processors are available to process that particular transaction request.

Configuration settings for each processor are optional and include but are not limited to the following information:

a) information on types of products for which the associated transaction request will not be accepted by the processor,

b) list of countries from which any transaction request originates will be rejected by the processor,

c) information on down-time, such as maintenance schedules, during which the processor does not accept any transaction requests,

d) information on types of billing methods offered by the processor,

e) information on the processor's preferences on types of product or types of billing methods,

f) information on whether the processor will be responsible for notifying the drop-ship companies, and

g) information on any promotional deals offered by the processor.

The analysis of the processing trends of each processor as a function of a set of variables include but are not limited to the following optional features:

a) historical data on the rate of success for completing transactions associated with a particular customer with respect to each processor,

b) a correlation between a given billing method and the rate of success for completing transactions for each processor,

c) a correlation between a given credit card company and the rate of success for completing transactions for each processor,

d) a correlation between types of products and the rate of success for completing transactions associated with each type of product for each processor,

e) a determination of each processor's willingness to accept risk, and

f) overall success rate in completing transactions by each processor during various periods of time of the day or season.

FIG. 4 is a flow chart that illustrates some of the details of the performance-commerce processing and optimization technique for determining the optimal processor. At block 402 of FIG. 4, the performance-commerce processing mechanism determines whether there are any processors available for accepting the transaction request. The determination of the availability of processors is based on the rules in the rules engine as applied to the individual transaction request's characteristics that are recognized in the interpretation steps of the performance-commerce processing mechanism. If it is determined that there are no processors available, then at block 404, the transaction request is denied. The appropriate message is sent to notify the consumer that her transaction request has been denied. For example, the consumer may receive a message to try re-initiating the transaction request at a later time.

If it is determined that there are processors available, then at block 406, it is determined whether there is more than one processor that is available. If there is more than one processor available, then at block 410, the optimal processor is determined based on the rules in the rules engine. The rules in the rules engine are applied to the individual transaction request's characteristics that are recognized in the interpretation steps of the performance-commerce processing mechanism. After the optimal processor is determined, block 412 indicates that control returns to block 204 of FIG. 2, where an attempt is made to process the transaction request using the optimal processor.

If at block 406, it is determined that there is only one processor that is available, the single available processor is considered to be the optimal processor and control is passed to block 204 of FIG. 2, as indicated by block 412 of FIG. 4.

### Confirmation and Merchant Fulfillment

FIG. 5 is a flow chart that illustrates the confirmation process and the merchant fulfillment process. At block 502, when a transaction is successfully completed, the processor sends confirmation of the completed transaction to the performance-commerce processing mechanism. The performance-commerce processing mechanism, in turn, sends confirmation of the completed transaction to the consumer who initiated the transaction request. Alternatively, the processor directly sends confirmation of the completed transaction to the consumer.

At block 504, fulfillment processing is performed by the performance-commerce processing mechanism, if necessary. When a transaction is successfully completed, the processor usually performs the fulfillment processing by notifying the appropriate drop-ship merchant that a product is to be shipped to the customer. However, the processor, may choose, instead, to have the performance-commerce processing mechanism perform the fulfillment processing. In such a case, the performance-commerce processing mechanism notifies the appropriate drop-ship merchant that a product is to be shipped to the customer. At block 506, the process exits from performance-commerce processing system. At block 508, the process ends.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any express definitions set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for optimized management of a request for transaction, the method comprising the computer-implemented acts of:
providing a turn-key interface;
automatically interfacing with a performance-commerce processing mechanism by using said turn-key interface, wherein said performance-commerce processing mechanism is configurable for:
developing a rules engine; and
directing said request for transaction for processing based on said rules engine.

2. The method of claim 1, wherein said performance-commerce processing mechanism is configurable for performing any function that a processor wishes to outsource.

3. The method of claim 1, further comprising performing a primary interpretation of said request for transaction.

4. The method of claim 1, further comprising performing a secondary interpretation of said request for transaction.

5. The method of claim 1, further comprising re-inserting said request for transaction for a secondary or other subsequent interpretation after said request for transaction is denied.

6. The method of claim 3, wherein performing said primary interpretation includes evaluating and verifying an identity of a source from which said request for transaction originated.

7. The method of claim 3, wherein performing said primary interpretation includes evaluating and verifying a geographical place of origin from which said request for transaction originated.

8. The method of claim 3, wherein performing said primary interpretation includes evaluating and verifying said request for transaction for fraud against data from a database that stores information on fraudulent transactions.

9. The method of claim 3, wherein performing said primary interpretation includes evaluating and verifying a geographical place of origin from which said request for transaction originated.

10. The method of claim 3, wherein performing said primary interpretation includes evaluating and verifying a type of product that is associated with said request for transaction.

11. The method of claim 4, wherein performing said secondary interpretation includes evaluating and verifying historical data that is associated with said request for transaction.

12. The method of claim 4, wherein performing said secondary interpretation includes evaluating and verifying payment methods that are associated with said request for transaction.

13. The method of claim 4, wherein performing said secondary interpretation includes evaluating and verifying cross-selling options and up-selling options that are available for said request for transaction.

14. The method of claim 1, wherein automatically interfacing with a performance-commerce processing mechanism further comprises establishing service relationships with a plurality of billing processors.

15. The method of claim 1, wherein developing a rules engine further comprises:
dynamically determining a set of rules for said rules engine, wherein said set of rules:
varies dynamically in characteristics; and
comprises a variable number of rules, wherein said variable number changes over time.

16. The method of claim 1, wherein developing a rules engine further comprises:
obtaining configuration settings that are associated with each processor of a plurality of processors; and
analyzing processing behavior of said each processor.

17. The method of claim 16, wherein said configuration settings includes information on types of product for which said request for transaction will be rejected by said each processor.

18. The method of claim 16, wherein said configuration settings includes a list of countries from which any request for transaction originates will be rejected by said each processor.

19. The method of claim 16, wherein said configuration settings includes information on down-time associated with said each processor.

20. The method of claim 16, wherein said configuration settings includes information on types of billing methods offered by said each processor.

21. The method of claim 16, wherein said configuration settings includes information on preferences on types of product and types of billing methods of said each processor.

22. The method of claim 16, wherein said configuration settings includes information on whether said each processor would like to perform merchant fulfillment duties.

23. The method of claim 16, wherein said configuration settings includes information on any promotional deals offered said each processor.

24. The method of claim 16, wherein analyzing processing behavior of said each processor further comprises analyzing historical data on a rate of success with respect to said each processor for completing transactions associated with a customer who has initiated said request.

25. The method of claim 16, wherein analyzing processing behavior of said each processor further comprises determining a correlation between a billing method and a rate of success for completing transactions for said each processor.

26. The method of claim 16, wherein analyzing processing behavior of said each processor further comprises determining a correlation between each credit card company that has a service agreement with said each processor and a rate of success for completing transactions for said each processor.

27. The method of claim 16, wherein analyzing processing behavior of said each processor further comprises determining a correlation between types of products and a rate of success for completing transactions associated with each type of product for said each processor.

28. The method of claim 16, wherein analyzing processing behavior of said each processor further comprises determining an overall success rate in completing transactions by said each processor during various periods of time in a day or season.

29. The method of claim 16, wherein analyzing processing behavior of said each processor further comprises determining said each processor's willingness to accept risk.

30. A method for managing a request for transaction from a plurality of requests for transaction, the method comprising the computer-implemented act of:
providing a turn-key plug-in interface, wherein said turn-key plug-in interface is configured to automatically interface with a transaction management system that provides intelligent processing of each request for transactions from said plurality of requests for transaction.

31. A method for managing requests for transactions, the method comprising the computer-implemented acts of:
establishing service with multiple billing processors;
developing a set of rules based on processing said requests for transaction;
determining, for processing said requests for transactions, an optimal billing processor from said multiple billing processors based on said set of rules; and
if said optimal billing processor is unable to process intelligent, then redirecting said requests for transactions based on said set of rules.

32. A system for managing a request for transaction from a plurality of requests for transaction, the system comprising:
a performance-commerce processing mechanism that includes:
one or more interpretation components for interpreting information associated with said request for transaction;
one or more rules engine;
an optimization component for optimizing, based on said one or more rules engine, a processing of said request for transaction; and
a turn-key plug-in interface, wherein said turn-key plug-in interface is configured to automatically interface with said performance processing mechanism.

33. A computer-readable medium carrying one or more sequences of instructions for managing a request for transaction from a plurality of requests for transaction,
wherein execution of the one or more sequences of instructions by one or more processors causes the one or more processors to perform the acts of:
providing a turn-key interface;
automatically interfacing with a performance-commerce processing mechanism by using said turn-key interface, wherein said performance-commerce processing mechanism is configurable for:
developing a rules engine; and
directing said request for transaction for processing based on said rules engine.
